(19) United States
(12) Patent Application Publication
(10) Pub. No.: US 2015/0095183 A1
(43) Pub. Date: Apr. 2, 2015

(54) Methods and Apparatus for Generating Recommendations

(71) Applicant: International Business Machines Corporation, Armonk, NY (US)

(72) Inventors: Michael Desmond, White Plains, NY (US); Sophia Krasikov, Katonah, NY (US); Natwar Modani, Haryana, IN (US); Seema Nagar, Bangalore, IN (US); Edith G. Schonberg, New York, NY (US); Harini Srinivasan, Tarrytown, NY (US)

(73) Assignee: International Business Machines Corporation, Armonk, NY (US)

(21) Appl. No.: 14/041,367

(22) Filed: Sep. 30, 2013

(51) Int. Cl. G06Q 30/06; G06Q 50/00

(52) U.S. Cl. CPC G06Q 30/0631; G06Q 50/01
USPC 705/26.7

(57) ABSTRACT

Systems and techniques for generating recommendations for items likely to be of interest to a user. Upon an indication that a recommendation may be needed by a user, a plurality of recommendations from different sources are generated and combined. Suitably, each recommendation includes parameters such as accuracy and confidence parameters. Combining the recommendations comprises adjusting the parameters based on a set of rules established by an operator of a system for combining recommendations. The rules may be adjusted by operator inputs through an interface and may be adjusted, if desired, during generation of a recommendation. At least one of the recommendation sources generates recommendations based on social grouping, wherein social groupings are identified based on connections between members and similarity of purchased between members, and wherein a recommendation for a specific user is generated by identifying groups to which the user belongs and items popular within such groups.

### FIELD OF THE INVENTION

One or more embodiments of the present invention relate generally to generating recommendations to users for products and services.

### BACKGROUND

Consumers enjoy a wide range of choices among goods and services. A consumer can, with little effort, uncover a staggering array of choices in the way of entertainment, clothing, financial services, travel, automobiles, electronics, beauty care and beauty products, and numerous other choices. Consumers can easily select the desired goods and services and enter into transactions. Where many consumers encounter problems, however, is in making the selection. So many alternatives are available that it is difficult to sort through the alternatives and make a selection. Numerous approaches to assisting consumers in making selections are available, such as reviews of goods and services provided by previous purchasers or users, and comments on discussion forums. However, searching for and reading such reviews and discussions is time consuming. One approach that has gained considerable interest is the automated generation of recommendations based on information about a consumer for whom the recommendation is being made, or related information, such as information about the choices of other consumers associated in some way with the consumer in question. There is enormous interest in developing ways to improve the performance of such automated generation of recommendations—to more accurately mimic, in an automated recommendation, the choice the consumer would make based on his or her own preferences.

### SUMMARY

In one embodiment of the invention, a method comprises, in response to an indication from a user that a recommendation of an item would be useful, assembling recommendations from a plurality of recommendation sources configured to generate recommendations of items to users based on estimates of user preferences, adjusting recommendations from the plurality of recommendation sources based on predefined rules, and processing the adjusted recommendations to generate a combined recommendation reflecting an estimate of the best selection among the recommendations from the plurality of sources.

In another embodiment of the invention, a method comprises dividing a population into social communities, identifying items suitable for recommendation to a user based on estimates of user preference, determining relative popularity of each item within a each social community, determining relative popularity of each item among the population as a whole, selecting a set of candidate items for potential recommendation to a specific user based at least in part on determinations of relative popularity of items among groups of users based on connections between the groups of users and the specific user, and selecting one or more items from the set of candidate items for recommendation to a specific user

In another embodiment of the invention, a method comprises, in response to an indication from a user that a recommendation of an item would be useful, assembling recommendations from a plurality of recommendation sources configured to generate recommendations of items to users based on estimates of user preferences, adjusting recommendations from the plurality of recommendation sources based on predefined rules and processing the adjusted recommendations to generate a combined recommendation reflecting an estimate of the best selection among the recommendations from the plurality of sources. By at least one of the recommendation sources, generation of recommendations comprise dividing a population into social communities, identifying items suitable for recommendation to a user based on estimates of user preference, determining relative popularity of each item within a each social community, determining relative popularity of each item among the population as a whole, selecting a set of candidate items for potential recommendation to a specific user based at least in part on determinations of relative popularity of items among groups of users based on connections between the groups of users and the specific user, and selecting one or more items from the set of candidate items for recommendation to a specific user.

### BRIEF DESCRIPTION OF THE SEVERAL VIEWS OF THE DRAWINGS

FIG. 1 illustrates a recommender system according to an embodiment of the present invention;

FIGS. 2 and 3 illustrate processes according to embodiments of the present invention;

FIG. 4 illustrates sets of users and products showing connections between users and between users and products, such as may be processed according to embodiments of the present invention;

FIG. 5 illustrates a process according to an embodiment of the present invention; and

FIG. 6 illustrates elements for carrying out one or more embodiments of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention recognize that numerous different approaches to automate recommendations are available. For example, recommendations may be made based on a user's past purchase history, based on similarities of items available for recommendation to items for which a user has given a favorable evaluation, based on evaluations or specific choices or purchases of consumers who have identified similarities to the consumer under consideration, based on overall popularity among a specific or general population, or based on any of a number of other considerations.

Producing recommendations based on combined information can take various approaches. In one approach, information of various types is combined and then used for recommendations using standard recommendation techniques. In another approach, separate recommendation sources are used, employing differing information, differing techniques, or both, and recommendations from these sources are combined.

In one or more embodiments, therefore, the invention comprises mechanisms for combining recommendations which may be generated independently by two or more information sources. Such mechanisms suitably are robust to incompleteness of information on which recommendations are to be based, and to differing levels of confidence. A single standardized interface may provide access to different information sources, as well as the ability to change the sources that are used or to include additional sources. One or more embodiments of the invention further provide rule based mechanisms to increase or decrease weightings of specific items in computing recommendations, or to block particular items from being offered recommendations. Embodiments of the present invention further implement rules in such a way as to be easily comprehensible and modifiable by an operator, including while data is being gathered or while a recommendation is being generated. Frameworks for combining recommendations may suitably be based on two parameters—namely, accuracy and confidence, with accuracy being the degree to which a reflection represents an actual choice that would be made by a user, and confidence being the probably that the computed accuracy is correct (suitably to within a specified margin of error). For example, a recommendation based no more data points will exhibit a higher confidence. If for example, the accuracy of course si is Ai and the confidence is Ci, then the combined accuracy is A_{c}=Sumᵢ(Wᵢ*Aᵢ*Cᵢ)/Sumᵢ(Wₑ*Cᵢ), where wᵢ is a weighting assigned to the source sᵢ.

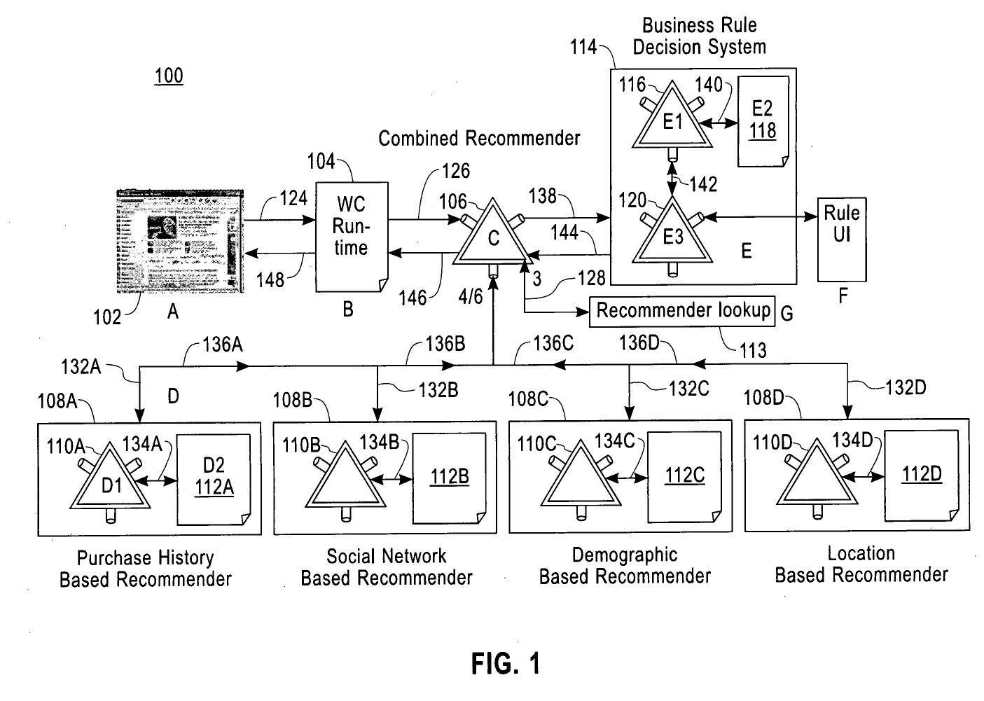

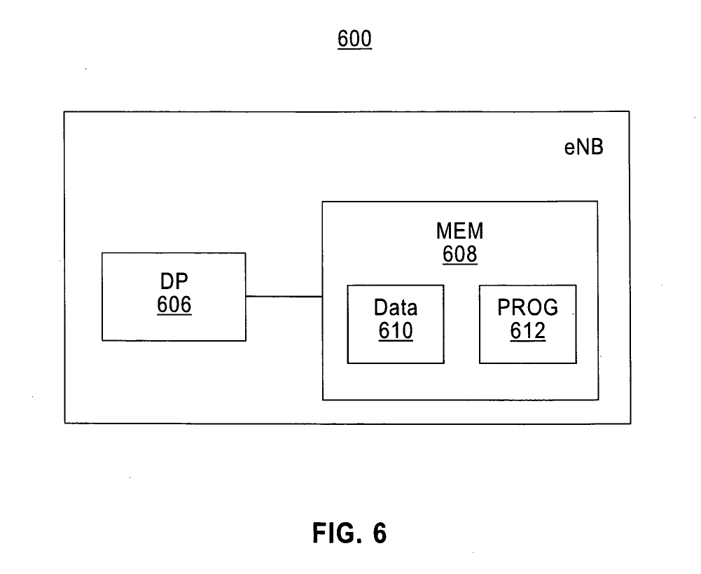

FIG. 1 illustrates a recommender system 100, suitably implemented by and as an operation or set of operations of a data processing device. An exemplary data processing device that may be used to implement a recommender system such as the recommender system 100 is illustrated in FIG. 6 and discussed in greater detail below. It will be recognized that discussions of specific implementations of a recommender system such as the recommender system 100 are exemplary only, and the recommender system 100 is not limited to implementation by a single data processing device, but may be distributed as desired. For example, recommendation sources for which recommendations are to be combined may conveniently be collected from a number of devices and may be combined at a single device for processing. Numerous other alternatives may be envisioned.

The recommender system 100 comprises a user interface, which may come in the form of a web browser 102. The user interface may, for example, accept explicit user requests for recommendations or may recognize events indicating a need for recommendations, such as navigating to a page presenting goods and services, such as entertainment or travel choices, for which recommendations would be useful. The web browser 102 passes information relating to its activities (for example, in the form of events) to a runtime analyzer 104 which captures each relevant event, and passes the event to a recommendation combiner 106. The recommendation combiner 106 receives recommendations from various sources 108A, 108B, 108C, and 108D. The source 108A may be, for example, a purchase history based recommender, the source 108B may be a social network based recommender, the source 108C may be a demographics based recommender, and the source 108D may be a location based recommender. The source 108A may appear to the combiner 106 as an externally exposed interface and logic 110A and data storage 112A, the source 108B may appear to the combiner 106 as an externally exposed interface and logic 110B and data storage 112B, the source 108C may appear to the combiner 106 as an externally exposed interface and logic 110C and data storage 112C, and the source 108D may appear to the combiner 106 as an externally exposed interface and logic 110D and data storage 112D. One exemplary embodiment of the externally exposed interface and logic of a source might be configured to appear as a web service, accessible to an individual user or to an automated information exchange mechanism, and the recommendation combiner 106 might be configured to provide inputs to each source in order to emulate a user seeking a recommendation from the source.

Each of the sources 108A-108D generates a recommendation data element, suitably in the form of an item identifier, an accuracy score, and a confidence level. For example, a recommendation data element might come in the form of <ID=3214 A, Acc=93, Con=80>. In the present example, the value given for “ID” is an identifier of list or database entry of items that may be recommended. The accuracy score of 93 represents the probability, expressed in percent, that a user with full information would make the same choice based on the user's preferences, and the confidence score of 80 indicates the probability, again expressed in percent, that the accuracy score is correct within a specified range, such as ±5%. Selection of sources to be consulted may be made with the assistance of a recommender lookup table 113, which may provide an index of items that may be recommended against sources such as the sources 108A-108D, so that only those sources will be consulted which can provide information for the specific items or categories of items needed.

The recommender system 100 further comprises a decision module 114, which makes adjustments to recommendations received from the different sources in order to form a combined recommendation. The decision module adjusts the accuracy and confidence scores of recommendations that have been contributed by individual recommendation sources. The adjustments are made in accordance with specific criteria that have been developed for the specific decision module being used.

The criteria may be developed by an operator of the decision module based on any number of desired objectives, such as to manage recommendations for the operator's own offerings, to manage recommendations among generally available offerings, to manage recommendations for particular categories of items, or any number of other objectives. The decision module 114 may comprise an externally appearing interface and processing element 116, which controls the operation of the decision module 114, taking data received from the recommendation combiner 106 (including recommendation data elements received by the recommendation combiner 106 from the sources 108A-108D), user selections passed along by the recommendation combiner 106, selections generated by the recommendation combiner 106 itself, and other data. The decision module 114 may also comprise a decision data store 118, which stores data such as specific criteria used by an operator to adjust recommendations from various sources to meet the goals of the operator, and a data interface 120, which may be implemented as a web service and which may be used to adjust (increase or decrease) scoring for recommended items—to adjust, for example, a score assigned to a recommendation. The decision module 114 may also comprise an operator user interface 120, providing a mechanism for an operator to define or redefine rules that may be taken into account to manage scoring or to combine recommendations from different sources.

FIG. 1 also illustrates messages, and information transfers and exchanges, involved in carrying out operations according to one or more embodiments of the present invention. A customer event 124 occurs, representing an information transfer between the web browser 102 and the runtime analyzer 104. The runtime analyzer 104 prepares a recommendation request for the combiner 106. The recommendation request 126 may come in the form of a web service call from the runtime analyzer 104 to a web service.

The combiner 106 requests a lookup 128 for recommendation sources from the recommender lookup table 113, and, once appropriate sources have been identified, makes requests 132A-132D to sources 108A-108D, respectively. The requests may provide inputs such as customer identifier, category identifier, transaction identifier, and other relevant information.

The external interface and logic elements 110A-110D of the sources 108A-108D, respectively, then prepare requests 134A-134D to their data sources 112A-112D to fulfill the requests to the combiner 106, the requests suitably including customer identifier and output profile information. The sources 108A-108D then respond to the requests 132A-132D with responses 136A-136D, with the responses 136A-136D suitably including customer identifier, transaction identifier, and recommendation information (such as recommended item, accuracy score, and confidence score).

The combiner 106 then prepares a decision request 138 to the decision module 114, with the request suitably including elements such as customer identifier, transaction identifier, and recommendation information received from each of the sources 108A-108D, and the external interface and logic 116 of the module 114 prepares a request 140 to its data store 118 for adjustment variables, as well as a request 142 for a decision based on the current business posture of the enterprise operating the system. The decision called for is one to decrease or increase the accuracy score of the recommendations. The module 114 then sends a response 144 to the combiner 106, providing decision information. The combiner 106 combines the recommendations using weighting and rule information from the module 114 and prepares a response 146 to the run-time analyzer 104, including the recommendation and relevant information relating to the recommendation. The run-time analyzer 104 prepares a customized message including the recommendation, and presents it to the user, suitably through the interface 102.

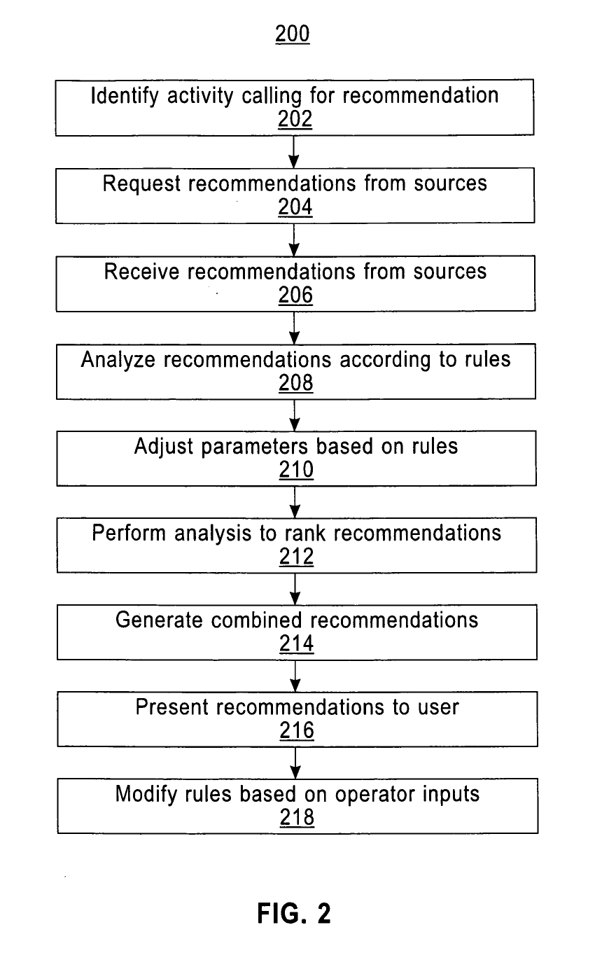

FIG. 2 illustrates a process 200 of combining recommendations according to an embodiment of the present invention. At block 202, an activity is identified, such as a user action or request manifested through a user interface, that a recommendation is needed, such as for a specific product or service within a category, or for a category of products or services within a variety of categories, and a specific product or service within the chosen category. At block 204, recommendations are requested from a plurality of recommendation sources. At block 206, recommendations are received from the sources, suitably with a recommendation including an identifier of the recommended item along with parameters such as accuracy and confidence. At block 208, the recommendations are analyzed according to rules for adjusting parameters and ranking and selecting recommendations. At block 210, adjustments to parameters such as accuracy and confidence parameters are made based on the rules. At block 212, analysis is performed to rank the recommendations from the different sources based on the adjusted parameters. At block 214, a combined recommendation is generated and at block 216, the combined recommendation is presented to a user.

As noted above, recommendations may be taken from any number of different sources operating in different ways, and, as noted in the present exemplary embodiment, the source 108B computes recommendations based on social networking. In this approach, the population of interest is divided into social communities and then popular items are identified for one or more communities or for each community, across the entire population, or both. A recommendation for a specific customer may be determined by incorporating information about, for example, the customer's social communities and friends as well as past purchases. In one approach, a set of products (which may be ranked) may be identified with a customer's social group. Products already purchased by the customer may be removed (if the product is of a type that is typically the subject of a single purchase rather than a recurring purchase). The remaining products in the set represent potential recommendations.

For purposes of generating recommendations, social groups may be defined as like-minded communities—those that exhibit a high degree of connectedness among themselves, and that exhibit similar taste (in particular, purchase similar items or rate the items similarly).

Therefore, a recommendation source according to an embodiment of the present invention examines a corpus of available data identifying persons who communicate with one another, and identifying purchase data—that is, which persons purchase which items or services, and then grouping persons appropriately.

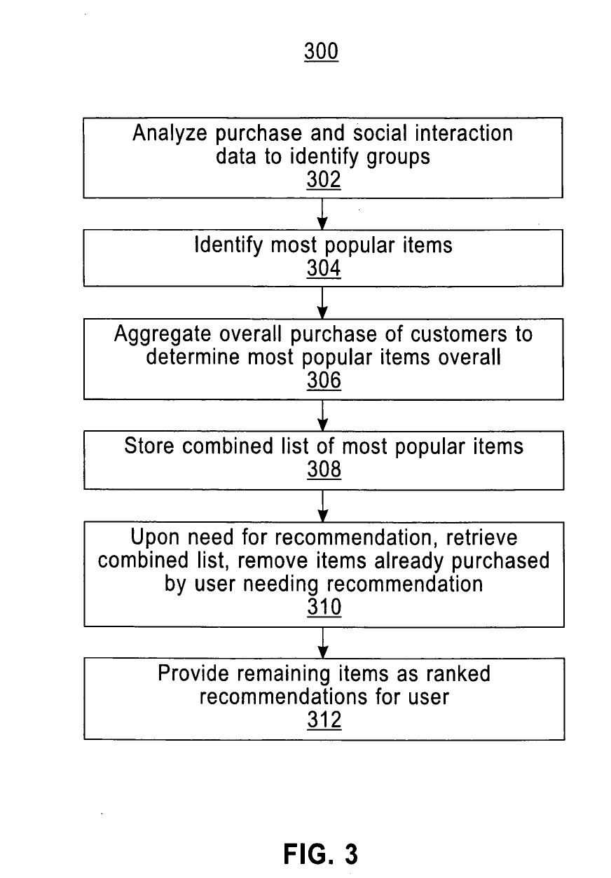

FIG. 3, therefore, presents a process 300 according to an embodiment of the present invention. At block 302, purchase and social interaction data is analyzed to identify groups that are socially well connected and likely to make similar choices. Such data may be taken, from example, from social networking sites among persons who have given permission for use of their data for making of recommendations for themselves and for others. Analysis may include identification of connections between persons—common interests, shared friends, similar assertions of interest in particular products or sellers of products, and the like, and similar actual purchases. At block 304, the most popular items (that is, goods and services purchased by or of interest to group members) are identified. Such identification may be, for example, a ranking of all products purchased by anyone in the community or may (for example, if it is desired to reduce the scope of searches) be an abbreviation of such a list—items exhibiting popularity above a specified threshold, for example, or items for which at least a minimum number of persons have exhibited interest. At block 306, overall purchases of customers are aggregated, to determine the most popular items overall. At block 308, a combined list of the most popular items is stored. Blocks 302-308 are directed to creating a ranked list or lists from which recommendations can be taken, and are performed upon initial setup, or when the list is to be updated—for example, periodically, or when a specified number of new customers has been added.

At block 310, upon a need for a recommendation—such as a manifestation of an intent to purchase, investigation or products, or an action indicating a possibility of purchase, such as visiting a web page providing information about items, the combined popular item list is retrieved and items which are not generally repeat-purchased and which have already been purchased by the user are removed. At block 312, the remaining items are provided as ranked recommendations for the specific user. Such recommendations may be produced as output of a recommender—for example, the recommender

As noted groups may be formed from like minded communities—groups whose members are connected such that they communicate frequently and are influenced by one another, and whose members have similar tastes and desires so that they purchase the same items or rate the same items similarly.

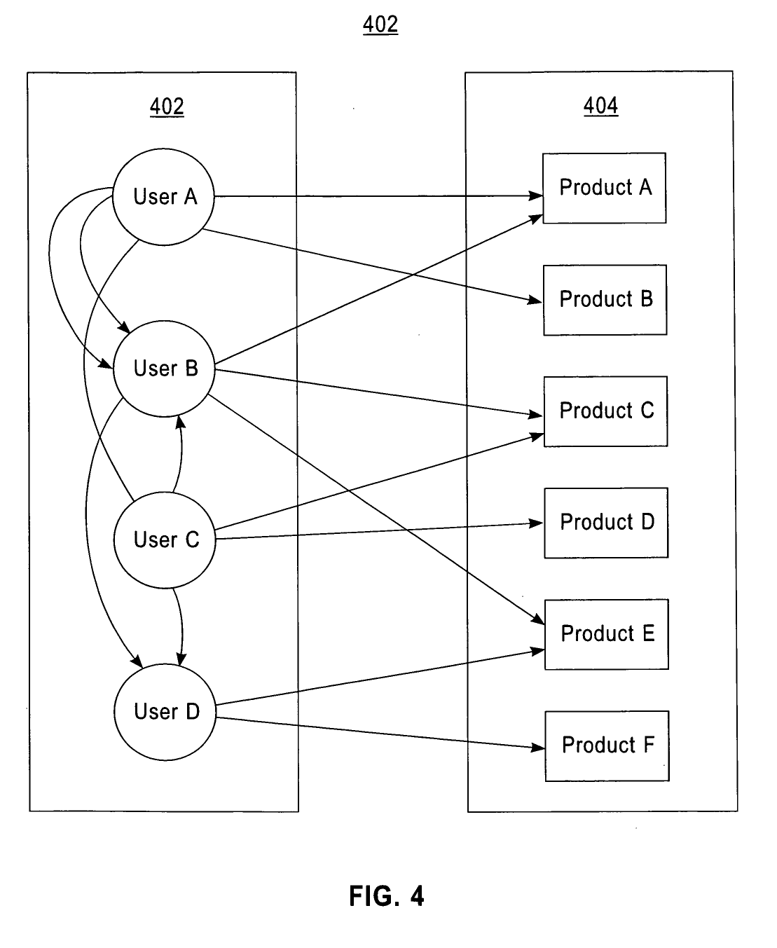

FIG. 4, therefore, illustrates collections 402 of persons and 404 of items, with arrows within the collection 402 showing connections between the members, and arrows between the collections 402 and 404 showing expressions of interest between of persons in items. This data is mined to identify communities and to rank item popularity within communities.

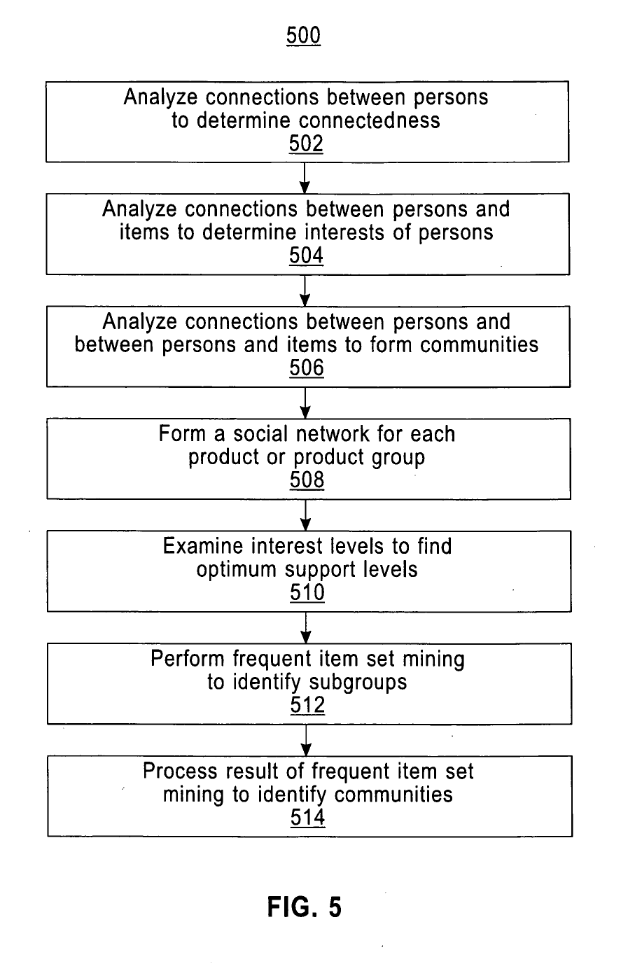

Thus, FIG. 5 illustrates a process 500 according to an embodiment of the present invention. At block 502, connections between persons are analyzed to determine connectedness, and at block 504, connections between persons and items are analyzed to determined interests of persons. At block 506, connections between persons and between persons and items are analyzed to identify purchasing groups for each product or product group. A purchasing group may be identified based on a combination of connectedness between members and of similarity of interests, so that, for example a person might be included in a purchasing group even if he or she exhibits low connectedness to other members, if he or she exhibits a sufficient degree of similarity of interest. At block 508, a social network for each product or product group may be formed, and at block 510, interest levels are examined to identify optimal support levels. At block 512, subgroups are identified such that they purchase many of the same products and are socially connected. Each grouping may suitably be treated as a transaction, with each person in a grouping being treated as an item. A frequent item set is produced based on these examinations and frequent item set mining is performed. At block 514, the result of this frequent item set mining is processed to identify communities.

Reference is now made to FIG. 600 for illustrating a simplified block diagram of details of an electronic device which may be implemented as a data processing device 600. The data processing device 600 may operate so as to record, receive, store, or process data used in carrying out one or more embodiments of the present invention. Any number of devices such as the data processing device 600 may be used, and may each may be configured as called for by the particular design of a system in which they may be used.

The data processing device 600 includes a data processor (DP) 606, and a memory (MEM) 608 that stores data 610 and one or more programs (PROGs) 612.

At least one of the PROGs 612 is assumed to include program instructions that, when executed by the associated DP, enable the electronic device to operate in accordance with the exemplary embodiments of this invention as was detailed above in detail.

In general, the exemplary embodiments of this invention may be implemented by computer software executable by the DP 606, or by hardware, or by a combination of software and/or firmware and hardware. The interactions between the major logical elements should be obvious to those skilled in the art for the level of detail needed to gain an understanding of the broader aspects of the invention beyond only the specific examples herein. It should be noted that the invention may be implemented with an application specific integrated circuit ASIC, a field programmable gated array FPGA, a digital signal processor or other suitable processor to carry out the intended function of the invention, including a central processor, a random access memory RAM, read only memory ROM, and communication ports for communicating between the various devices.

The MEM 608 may be of any type suitable to the local technical environment and may be implemented using any suitable data storage technology, such as semiconductor based memory devices, magnetic memory devices and systems, optical memory devices and systems, fixed memory and removable memory. The DP 606 may be of any type suitable to the local technical environment, and may include one or more of general purpose computers, special purpose computers, microprocessors, digital signal processors (DSPs) and processors based on a multi-core processor architecture, as non-limiting examples.

At least one of the memories is assumed to tangibly embody software program instructions that, when executed by the associated processor, enable the electronic device to operate in accordance with the exemplary embodiments of this invention, as detailed by example above. As such, the exemplary embodiments of this invention may be implemented at least in part by computer software executable by the DP 606 of the data processing device, or by hardware, or by a combination of software and hardware.

Various embodiments of the present invention take provide recommendations to persons showing interest in purchasing or otherwise receiving items or access to items

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

We claim:

1. A method comprising:
in response to an indication from a user that a recommendation of an item would be useful:
assembling recommendations from a plurality of recommendation sources configured to generate recommendations of items to users based on estimates of user preferences;
adjusting recommendations from the plurality of recommendation sources based on predefined rules; and
processing the adjusted recommendations to generate a combined recommendation reflecting an estimate of the best selection among the recommendations from the plurality of sources.

2. The method of claim 1, wherein wherein each recommendation includes one or more parameters and wherein relative rankings of recommendations are determined based on the one or more parameters.

3. The method of claim 2, wherein the one or more parameters comprise at least one of an accuracy parameter and a confidence parameter.

4. The method of claim 2, wherein the one or more parameters comprise an accuracy parameter and a confidence parameter.

5. The method of claim 3, wherein the predefined rules comprise rules for adjusting one or more of confidence and accuracy parameters.

6. The method of claim 1, further comprising modifying the predefined rules based on operator inputs.

7. The method of claim 6, wherein modifying the predefined rules based on operator inputs takes place during generation of a recommendation.

8. A method comprising:
dividing a population into social communities;
identifying items suitable for recommendation to a user based on estimates of user preference;
determining relative popularity of each item within a each social community;
determining relative popularity of each item among the population as a whole;
selecting a set of candidate items for potential recommendation to a specific user based at least in part on determinations of relative popularity of items among groups of users based on connections between the groups of users and the specific user; and
selecting one or more items from the set of candidate items for recommendation to a specific user.

9. The method of claim 8, wherein selecting one or more items from the set of candidate items comprises removing items already purchase by the specific user.

10. The method of claim 8, wherein selecting the set of candidate items comprises identifying one or more sets of items popular among one or more communities to which the specific user belongs, identifying popular items among users who are socially connected to the specific user, and combining the popular items among the one or more communities and the socially connected users.

11. The method of claim 10, wherein identifying the popular items among the socially connected users comprises aggregating the purchases of the socially connected users in order to find the most popular items among them.

12. The method of claim 10, wherein combining the set of items popular among the communities and the set of items popular among the socially connected users comprises assigning a weighting to each set of items.

13. The method of claim 8, wherein dividing the population into social communities comprises:
collecting and analyzing social interaction data and purchase data;
forming a social network for each product group;
identifying maximal connected groupings for each social network;
performing frequent item set mining to identify subgroups that purchase similar products and whose members are connected to one another; and
assembling members of subgroups into communities based on similarities.

14. An apparatus comprising:
at least one processor;
memory storing computer program code;
wherein the memory storing the computer program code is configured to, with the at least one processor, cause the apparatus to at least:
in response to an indication from a user that a recommendation of an item would be useful:
assemble recommendations from a plurality of recommendation sources configured to generate recommendations of items to users based on estimates of user preferences;
adjust recommendations from the plurality of recommendation sources based on predefined rules; and
process the adjusted recommendations to generate a combined recommendation reflecting an estimate of the best selection among the recommendations from the plurality of sources.

15. The apparatus of claim 14, wherein wherein each recommendation includes one or more parameters and wherein relative rankings of recommendations are determined based on the one or more parameters.

16. The apparatus of claim 15, wherein the one or more parameters comprise at least one of an accuracy parameter and a confidence parameter.

17. The apparatus of claim 15, wherein the one or more parameters comprise an accuracy parameter and a confidence parameter.

18. The apparatus of claim 15, wherein the predefined rules comprise rules for adjusting one or more of confidence and accuracy parameters.

19. The apparatus of claim 14, further comprising modifying the predefined rules based on operator inputs.

20. The apparatus of claim 19, wherein modifying the predefined rules based on operator inputs takes place during generation of a recommendation.
